(19) United States
(12) Patent Application Publication
(10) Pub. No.: US 2025/0236070 A1
(43) Pub. Date: Jul. 24, 2025

(54) Self-Centering and Self-Mixing Semi-Flexible Coaxial Nozzle, and Manufacturing Method Thereof

(71) Applicant: Henan Polytechnic University, Jiaozuo (CN)

(72) Inventors: Yu Li, Jiaozuo (CN); Pingyan Bian, Jiaozuo (CN); Jianhui Liu, Jiaozuo (CN); Xiaohui Zhang, Jiaozuo (CN); Haijun Qu, Jiaozuo (CN); Jianping Wang, Jiaozuo (CN); Shilei Li, Jiaozuo (CN); Hua Li, Jiaozuo (CN); Yahui Qiao, Jiaozuo (CN); Shengzhao Qiao, Jiaozuo (CN)

(21) Appl. No.: 19/174,884

(22) Filed: Apr. 9, 2025

Related U.S. Application Data
(63) Continuation of application No. PCT/CN2023/078949, filed on Mar. 10, 2023.

(30) Foreign Application Priority Data
Feb. 27, 2023 (CN) 202310172035.2

(51) Int. Cl. B29C 64/209; B33Y 30/00

(52) U.S. Cl. CPC B29C 64/209; B33Y 30/00

(57) ABSTRACT

This invention discloses a self-centering and self-mixing semi-flexible coaxial nozzle capabilities, and its manufacturing method. The invention comprises an upper cover, a semi-flexible inner needle, a three-way casing, a three-way convex platform and an outer needle, wherein the bottom of the upper cover is screwed on the three-way casing; the central part of the three-way casing is provided with the semi-flexible inner needle and the outer needle is screwed on the bottom of the three-way casing; the semi-flexible inner needle extends to the inside of the outer needle through the head of the three-way casing; and two three-way convex platform are screwed on the left and right side surfaces of the three-way casing. The invention has the following beneficial effects: the semi-flexible inner needle self-centers via fluid dynamics to correct coaxiality errors; the three-way mixer enables passive material blending; and a sealed assembly (fixed plate, fixture block) ensures leak-proof rigidity.

### TECHNICAL FIELD

This invention relates to the fields of tissue engineering and bio-3D printing technology, specifically to a self-centering and self-mixing semi-flexible coaxial nozzle, and its manufacturing method.

### BACKGROUND

Bio-3D printing plays a crucial role in the medical field, helping to address the shortage of organ donors and issues related to immune rejection, thereby realizing the potential for human tissue and organ transplantation. Coaxial extrusion-based 3D printing technology and electrospinning technology are widely used in bioengineering. The preparation of hollow fibers that resemble blood vessels using coaxial reaction flow has become a major research hotspot in the field of biomanufacturing. However, traditional coaxial nozzles face challenges in maintaining the coaxiality of the inner and outer channels, leading to issues such as blockages and cleaning difficulties. These issues directly affect the quality of the hollow fibers.

Patent document (application number CN201811543369.1) discloses a novel extrusion-based bio-3D printing coaxial nozzle and method. This design achieves the mixing of multiple materials within the coaxial nozzle through nested tubes and ensures uniform liquid flow by incorporating material guiding plates. Although this method can form a hollow tube, the complex connection forms highlight the ongoing challenge of maintaining coaxiality in coaxial nozzles. Patent document (application number CN2017202337) describes a novel flexible 3D bio-printing nozzle. This design utilizes electromagnetic fields and fluid dynamics to center the flexible core material and employs the Magnetostrictive effect generated by the magnetic field to prevent backflow when liquid flow ceases. However, the flexible core tends to collapse after liquid stoppage, resulting in flat jet streams upon re-initiation of flow, which compromises the maintenance of a tubular structure.

This invention provides a self-centering and self-mixing semi-flexible coaxial nozzle, along with its manufacturing method. The core nozzle features semi-flexibility, replacing the conventional rigid nozzles with a flexible hose, and evenly arranging several segments of rigid short tubes within the tube. On the one hand, the fluid self-centering effect can be utilized to drive the flexible hose to perform coaxial correction and compensation with the outer needle. On the other hand, the rigid short tubes ensure the tubular structure of the core channel, while the segmented arrangement maximizes the retention of the overall flexibility of the core, hence termed “semi-flexible”. Additionally, this invention adopts a physical stirring mixing method, enabling self-assisted mixing of materials after injection, resulting in more uniform material blending.

### SUMMARY

The purpose of this invention is to provide a self-centering and self-mixing semi-flexible coaxial nozzle, along with its manufacturing method, to address the problems presented in the background technology.

To achieve this objective, the invention proposes the following technical solution: a self-centering and self-mixing semi-flexible coaxial nozzle, comprising an upper cover, semi-flexible inner needle, three-way casing, three-way convex platform, and outer needle. The bottom thread of the upper cover is installed on the three-way casing, with the semi-flexible inner needle placed in the middle of the three-way casing, and the bottom thread of the three-way casing installed with the outer needle. The semi-flexible inner needle extends through the head of the three-way casing to the inside of the outer needle, with two three-way convex platforms threaded on the left and right sides of the three-way casing, and an inner cavity provided on the inner wall of the upper cover.

Preferably, the semi-flexible inner needle comprises a needle rigid component, a flexible hose, several rigid short tubes, and a mixing component, with the needle rigid component positioned on the three-way casing.

Preferably, the bottom of the needle rigid component is encased in a flexible hose, the needle rigid component of the needle rigid component is fixedly encased in a mixing component, and a rigid short tube is placed in the middle of the flexible hose in sections.

Preferably, the mixing component includes a central casing, spiral blades, and leakage holes, with the spiral blades fixedly connected to the outer wall of the central casing, and the surface of the spiral blades uniformly provided with leakage holes.

Preferably, the head of the needle rigid component of the semi-flexible inner needle is fixedly connected to a fixing plate along the mouth. The fixing plate is embedded with the fixture block on its outer edge. The outer wall of the fixture block is securely connected to a sealing casing, which fits snugly against the inner wall of the three-way casing.

Preferably, the manufacturing method of the self-centering and self-mixing semi-flexible coaxial nozzle includes the following steps:

1. Using wire cutting method to divide a rigid needle into a needle rigid component and several rigid short tubes, fitting the hollow mixing component at the middle position of the needle rigid component, and firmly connecting the mixing component and the needle rigid component together using strong adhesive or welding. Inserting several fine copper wires into the needle rigid component, evenly embedding the rigid short tube on these wires.

2. Cutting a piece of flexible film material, applying a layer of glue to it, tightly winding polyethylene around the needle rigid component for 1 to 2 turns through the needle rigid component and the fine copper wires to form a flexible hose.

3. Slowly pulling out the fine copper wires one by one to evenly embed the rigid short tube within the flexible hose, ensuring the flexible hose is tightly wound around the needle rigid component to form a semi-flexible inner needle. On one hand, utilizing the self-centering effect of the fluid to drive the flexible hose for coaxial alignment and compensation with the outer needle; on the other hand, the rigid short tube ensures the tubular structure of the core channel, while the embedded arrangement maximally retains the flexibility of the overall core structure, hence termed “semi-flexible”.

4. Assembling the upper cover, semi-flexible inner needle, three-way casing, three-way convex platform, outer needle, etc., through pressing or threaded connections to form a self-centering and self-mixing semi-flexible coaxial nozzle.

Compared to existing technologies, the beneficial effects of the present invention, the self-centering and self-mixing semi-flexible coaxial nozzle and its manufacturing method, are as follows:

1. Versatile Extrusion Capabilities: The present invention utilizes a self-centering and self-mixing semi-flexible coaxial nozzle that can meet both single-material extrusion and cross-linking extrusion of two materials.

2. Improved Coaxiality: By leveraging the self-centering effect of fluid, the flexible hose portion of the semi-flexible inner needle automatically centers under fluid action, compensating for low coaxiality caused by machining and assembly inaccuracies of nozzle components.

3. Structural Integrity: The uniformly spaced rigid short tubes arranged inside the flexible needle core ensure the maintenance of the tubular structure both before and after liquid supply.

4. Enhanced Mixing Efficiency: With the mixing component, after material injection, the rotating blades on the surface of the mixing component assist in mixing the fluid materials entering the three-way convex platform, ensuring more thorough material mixing. The mixing method employs a physical mixing approach, eliminating the need for electrical control and thus simplifying the structure.

5. Effective Sealing: The present invention ensures the sealing between the needle rigid component and the three-way casing by using a fixing plate, a fixture block, and sealing casings.

### BRIEF DESCRIPTION OF THE FIGURES

FIG. 1 is a schematic diagram of the three-dimensional structure of the present invention.

FIG. 2 is a schematic diagram of the main cross-sectional structure of the present invention.

FIG. 3 is a schematic diagram of the distribution structure of the semi-flexible inner needle components of the present invention.

FIG. 4 is a schematic diagram of the main structure of the mixing component of the present invention.

FIG. 5 is an enlarged schematic diagram of area A (FIG. 2) of the present invention.

Wherein, 1. Upper cover; 2. Semi-flexible inner needle; 201. Needle rigid component; 2011. Fixed plate; 2012. Fixture block; 2013. Sealing casing; 202. Rigid short tubes; 203. Flexible hose; 204. Mixing component; 2041. Central casing; 2042. Spiral blade; 2043. Leakage hole; 3. Three-way casing; 4. Three-way convex platform; 5. Outer needle.

### DETAILED DESCRIPTION OF THE INVENTION

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments of the present invention, all other embodiments obtained by ordinary technicians in this field without creative work are within the scope of protection of the present invention.

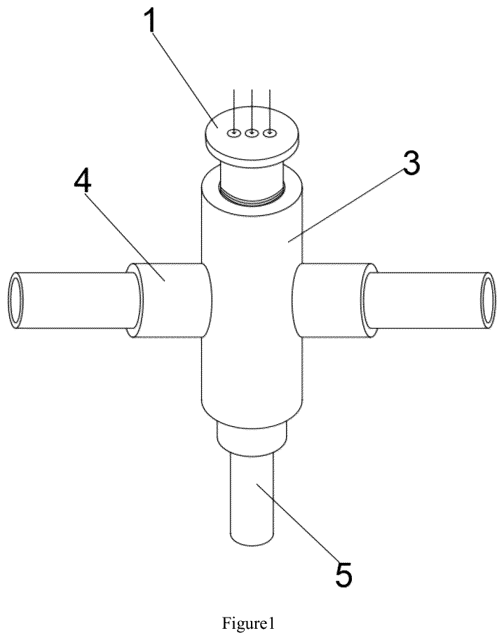

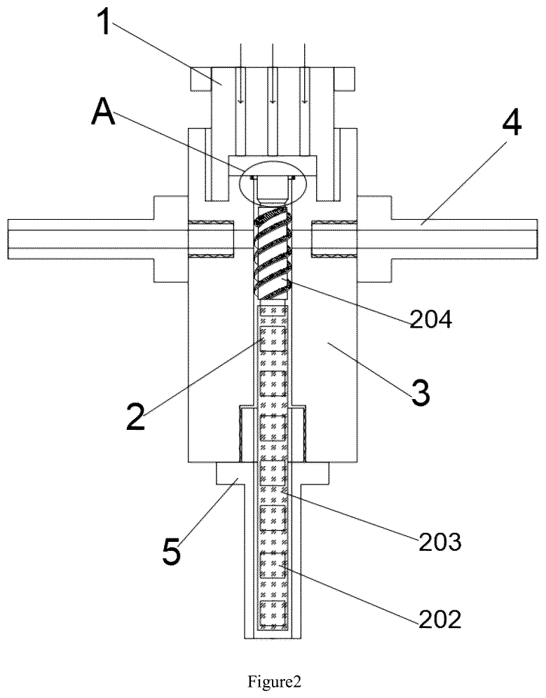

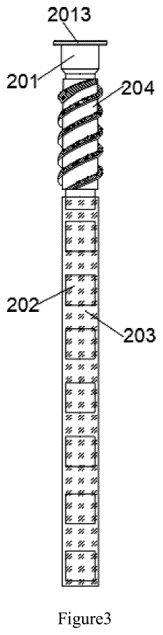

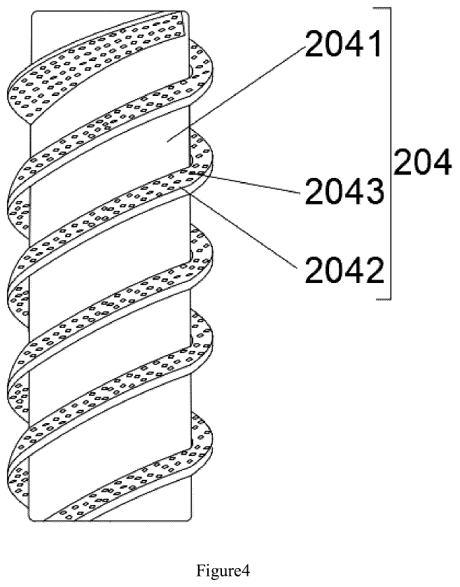

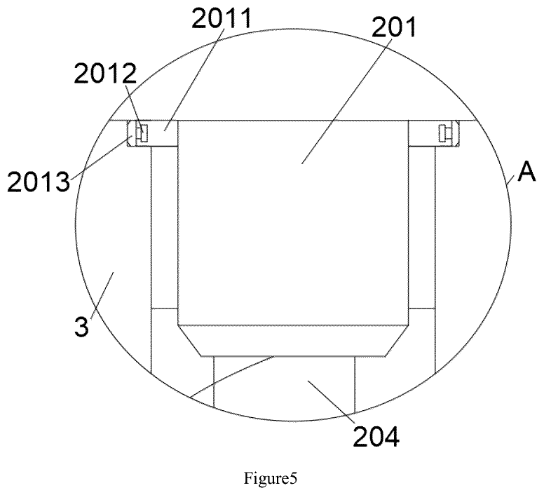

Refer to FIGS. 1-5. The present invention provides a technical solution: a self-centering and self-mixing semi-flexible coaxial nozzle and its production method, comprising an upper cover 1, a semi-flexible inner needle 2, a three-way casing 3, a three-way convex platform 4, and an outer needle 5. The bottom thread of the upper cover 1 is installed on the three-way casing 3, and the middle part of the three-way casing 3 is equipped with the semi-flexible inner needle 2, and the bottom thread of the three-way casing 3 is installed with the outer needle 5. The semi-flexible inner needle 2 extends from the head of the three-way casing 3 to the inside of the outer needle 5. The surface of the three-way casing 3 is threaded with the three-way convex platform 4, and the inner wall of the upper cover 1 is provided with a cavity.

The semi-flexible inner needle 2 includes a needle rigid component 201, a flexible hose 203, a rigid short tube 202, and a mixing component 204. The needle rigid component 201 is placed on the three-way casing 3, and the bottom of the needle rigid component 201 is connected to the flexible hose 203, and the middle of the needle rigid component 201 is fixedly connected to the mixing component 204. The mixing component 204 includes a central casing 2041, spiral blades 2042, and leakage holes 2043. The outer wall of the central casing 2041 is fixedly connected with the spiral blades 2042, and the surface of the spiral blades 2042 is uniformly provided with leakage holes 2043. The middle section of the flexible hose 203 is equipped with rigid short tubes 202. Increasing the mixing component 204 can allow the fluid material to flow along the curvature of the blades, and the leakage holes on the spiral blades can allow the flowing fluid material to flow out from the bottom, thus achieving multi-directional mixing of the fluid material. The mixed fluid material is uniformly wrapped in the space between the flexible hose 203 and the three-way casing 3. At the same time, the rigid short tubes 202 are evenly wrapped in the flexible hose 203, allowing the semi-flexible inner needle 2 to maintain a tubular structure under the action of fluid material and reduce the coaxiality error with the outer needle 5 under the fluid pressure of the shell fluid.

The head of the needle rigid component 201 is fixedly connected with a fixing plate 2011 along the mouth, and the outer edge of the fixing plate 2011 is embedded with a fixture block 2012. The outer wall of the fixture block 2012 is fixedly connected with a sealing casing 2013, and the outer wall of the sealing casing 2013 fits snugly with the inner wall of the three-way casing 3. By setting the sealing casing 2013, the sealing casing 2013 can maintain the sealing connection with the three-way casing 3.

### Embodiment 2

A method for producing a self-centering and self-mixing semi-flexible coaxial nozzle begins by cutting a rigid needle into a needle rigid component 201 and several rigid short tubes 202 using wire cutting.

The hollow internal mixing component 204 is then fitted at the midpoint of the needle rigid component 201, and the mixing component 204 is securely fixed to the needle rigid component 201 using strong adhesive or welding.

Several fine copper wires are inserted into the needle rigid component 201, and the rigid short tubes 202 is uniformly embedded along the fine copper wires. A piece of flexible film material, such as polyethylene film, is then cut, coated with adhesive, and tightly wound around the needle rigid component 201 along with the fine copper wires, forming a flexible hose 203.

The fine copper wires are then slowly removed one by one, allowing the rigid short tubes 202 to be uniformly embedded within the tube, with the flexible hose 203 tightly wound around the needle rigid component 201, forming a semi-flexible internal needle. On one hand, the fluid self-centering effect is utilized to drive the flexible hose 203 to correct and compensate for the coaxiality with the outer needle 5; on the other hand, the rigid short tubes 202 ensures the tubular structure of the core channel, while the embedded arrangement maximally preserves the flexibility of the overall structure of the core, hence termed as “semi-flexible.”

Finally, the upper cover 1, semi-flexible internal needle 2, three-way casing 3, three-way convex platform 4, and outer needle 5 are combined through compression or threaded connections to form a self-centering and self-mixing semi-flexible coaxial nozzle functions.

In summary, as illustrated in FIGS. 1-5, when using the self-centering and self-mixing semi-flexible coaxial nozzle and its manufacturing method, the semi-flexible inner needle 2 is first placed inside the three-way casing 3. Subsequently, the upper cover 1 is threaded onto the three-way casing 3, and correspondingly, the three-way convex platform 4 and the outer needle 5 are installed on the sides and bottom of the three-way casing 3. Shell fluid flows in from the two three-way convex platforms 4, and when passing through the semi-flexible inner needle, it is influenced by the structure of its mixing component 204, causing the injected shell fluid to fully drive mixing and wrap around the flexible hose 203 as it flows downward. Meanwhile, core fluid is injected from the top of the upper cover 1, flowing into the semi-flexible inner needle from the upper cover 1. At this point, the shell fluid pushes the semi-flexible inner needle to deform, causing its outlet end to approach the ideal center of the three-way casing 3. The shell fluid and core fluid form coaxial flow at the outer needle 5. This represents the operational principle of the self-centering and self-mixing, semi-flexible coaxial nozzle.

Although embodiments of the present invention have been shown and described, it will be appreciated by those skilled in the art that various changes, modifications, substitutions and variations may be made to the embodiments without departing from the principles and spirit of the present invention, and that the scope of the present invention is defined by the appended claims and their equivalents.

1. A self-centering and self-mixing semi-flexible coaxial nozzle, comprising an upper cover (1), a semi-flexible inner needle (2), a three-way casing (3), a three-way convex platform (4), and an outer needle (5), characterized in that: the bottom thread of the upper cover (1) is installed on the three-way casing (3), the central portion of the three-way casing (3) houses the semi-flexible inner needle (2), and the bottom thread of the three-way casing (3) is installed with the outer needle (5); the semi-flexible inner needle (2) extends through the head of the three-way casing (3) to the inside of the outer needle (5), and two three-way convex platforms (4) are threaded onto the left and right sides of the three-way casing (3); the inner wall of the upper cover (1) is provided with a cavity.

2. The self-centering and self-mixing semi-flexible coaxial nozzle according to claim 1, characterized in that the semi-flexible inner needle (2) comprises a needle rigid component (201), a flexible hose (203), several rigid short tubes (202), and a mixing component (204), wherein the needle rigid component (201) is positioned on the three-way casing (3).

3. The self-centering and self-mixing semi-flexible coaxial nozzle according to claim 2, characterized in that the bottom of the needle rigid component (201) is encased in the flexible hose (203), the middle section of the flexible hose (203) is fixedly encased in the mixing component (204), and the middle segment of the flexible hose (203) is equipped with the rigid short tube (202).

4. The self-centering and self-mixing semi-flexible coaxial nozzle according to claim 3, characterized in that the mixing component (204) comprises a central casing (2041), spiral blades (2042), and leakage holes (2043), wherein the outer wall of the central casing (2041) is fixedly connected to spiral blades (2042), and the surface of the spiral blades (2042) is uniformly provided with leakage holes (2043).

5. The self-centering and self-mixing semi-flexible coaxial nozzle according to claim 2, characterized in that the head portion of the needle rigid component (201) is fixedly connected to a fixing plate (2011) at its mouth, wherein the outer edge of the fixing plate (2011) is embedded with a fixture block (2012), the outer wall of which is fixedly connected to a sealing casing (2013), and the outer wall of the sealing casing (2013) fits snugly against the inner wall of the three-way casing (3).

6. The method for manufacturing a self-centering and self-mixing semi-flexible coaxial nozzle, as defined in any one of claim 1, the method comprises the following steps: using wire cutting method to divide a rigid needle into a needle rigid component (201) and several rigid short tubes (202); inserting a hollow mixing component (204) into the middle position of the needle rigid component (201), and firmly connecting the mixing component (204) and the needle rigid component (201) together using strong adhesive or welding; inserting several fine copper wires into the needle rigid component (201), and evenly embedding the rigid short tubes (202) onto the fine copper wires; cutting a piece of flexible film material (such as polyethylene film), applying a layer of glue on it, and tightly winding the polyethylene around the needle rigid component (201) for 1 to 2 turns through the needle rigid component (201) and the fine copper wires to form a flexible hose (203); slowly pulling out each fine copper wire one by one, so that the rigid short tubes (202) are evenly embedded inside the hose, and the flexible hose (203) is tightly wound around the needle rigid component (201), forming a semi-flexible inner needle; on one hand, the fluid's self-centering effect drives the flexible hose (203) to perform coaxial correction and compensation with the outer needle (5); on the other hand, the rigid short tubes (202) ensure the tubular structure of the core channel, while the segmental arrangement maximizes the flexibility of the overall structure of the core, thus forming the so-called “semi-flexible”; finally, assembling the upper cover (1), semi-flexible inner needle (2), three-way casing (3), three-way convex platform (4), outer needle (5), etc., through pressing or threaded connection, to form a self-centering and self-mixing semi-flexible coaxial nozzle.
